(19) United States
(12) Patent Application Publication
(10) Pub. No.: US 2026/0100520 A1
(43) Pub. Date: Apr. 9, 2026

(54) THREE-DIMENSIONAL ANTENNA ARRANGEMENT

(71) Applicant: Robert Bosch GmbH, Stuttgart (DE)

(72) Inventor: Christoph Dahl, Leonberg (DE)

(21) Appl. No.: 19/300,749

(22) Filed: Aug. 15, 2025

(30) Foreign Application Priority Data
Oct. 4, 2024 (DE) 10 2024 209 716.0

(51) Int. Cl. H01Q 21/28; H01Q 15/00

(52) U.S. Cl. CPC H01Q 21/28; H01Q 15/0093

(57) ABSTRACT

A three-dimensional antenna arrangement for a device with multiple transmitting antenna elements and multiple receiving antenna elements. The transmitting antenna elements and the receiving antenna elements are arranged on a regular three-dimensional lattice and a virtual antenna arrangement of virtual antenna elements results from geometric convolution of an arrangement of the transmitting antenna elements and of an arrangement of the receiving antenna elements, wherein a phase difference of the virtual antenna elements of the virtual antenna arrangement is measurable in a third spatial dimension.

### CROSS REFERENCE

The present application claims the benefit under 35 U.S.C. § 119 of German Patent Application No. DE 10 2024 209 716.0 filed on Oct. 4, 2024, which is expressly incorporated herein by reference in its entirety.

### FIELD

The present invention relates to a three-dimensional antenna arrangement and in particular to a fractal 3D MIMO antenna arrangement for radar applications.

### BACKGROUND INFORMATION

Planar antenna arrangements are typically used for MIMO radar systems. Two-dimensional fractal antenna arrangements can be used to optimize MIMO radar systems by generating circle-like virtual arrangements on a hexagonal lattice, as described in Germany Patent Application No. DE 10 2020 102 033 A1.

A group antenna uses the phase shift Δφ of the transmitting elements arranged in a matrix to achieve bundling through interference. The transmitted energy is amplified in the desired direction, while the unwanted directions are canceled out by destructive interference. The individual transmitting elements do not require any bundling devices.

However, the angular resolution of planar group antennas decreases with increasing elevations and/or azimuth angles due to the aperture projection. In planar group antennas, if the element distance between the antenna elements is too large, periodic ambiguities arise that are difficult to resolve in signal processing. In addition, in planar MIMO arrangements, multipath paths with different transmission and reception directions lead to unwanted ghost targets.

### SUMMARY

According to a first aspect, the present invention provides a three-dimensional antenna arrangement. According to an example embodiment of the present invention, the antenna arrangement includes multiple transmitting antenna elements and multiple receiving antenna elements, wherein the transmitting antenna elements and the receiving antenna elements are arranged on a regular three-dimensional lattice and a virtual antenna arrangement of virtual antenna elements results from geometric convolution of an arrangement of the transmitting antenna elements and of an arrangement of the receiving antenna elements, wherein a phase difference of the virtual antenna elements of the virtual antenna arrangement is measurable in a third spatial dimension.

A 3D MIMO arrangement of the antenna elements makes it possible to measure the phase difference of the antenna elements of the virtual antenna array in an additional third spatial dimension. As a result, the wave vector of the transmitted and received waves is also determined in three dimensions.

The antenna arrangement according to the present invention also makes it possible to achieve a constant angular resolution over a very wide angular range in azimuth and/or elevation (>180°) due to the three-dimensional arrangement of the transmitting antenna elements and the receiving antenna elements.

The three-dimensional antenna arrangement according to the present invention allows for unambiguous classification and filtering of ambiguities, which in turn makes it possible to increase the element distance between antenna elements. As a result, it is possible with the same number of transmitting antenna elements and receiving antenna elements to improve the angular resolution of a MIMO radar device or any other device that processes the received signals of the three-dimensional antenna arrangement.

At the same time, the approach according to the present invention can be used to distinguish and filter direct paths from multipath paths with different transmission and reception directions, whereby ghost targets are reduced.

In a possible example embodiment of the three-dimensional antenna arrangement according to the present invention, the transmitting antenna elements and the receiving antenna elements each have a fractal arrangement of the antenna elements.

According to an example embodiment of the present invention, a fractal antenna arrangement is a configuration of antenna elements that uses the principles of fractal geometry to achieve certain advantages in antenna technology. Fractal geometry is characterized by structures that are self-similar and often complex, even though they consist of simple, repeating patterns.

Fractal antennas have a structure that is similar at different scales. This means that parts of the antenna look similar to the entire antenna, just on a smaller scale. Due to the fractal structure, the antenna arrangement according to the present invention can be made more compact, which is in particular important in applications where space matters, such as in mobile devices.

The three-dimensional fractal arrangement of antenna elements on an optimal regular lattice maximizes the distance between the ambiguities for a given number of transmitting antenna elements and receiving antenna elements. At the same time, coupling and mutual shading of the antenna elements is avoided.

In a possible example embodiment of the present invention, the fractal arrangement of the antenna elements makes it possible to implement the three-dimensional arrangement of the antenna elements in a simple manner on the basis of a planar antenna arrangement with attached linear waveguides, which can inter alia be implemented in waveguide technology.

In addition, in a possible example embodiment of the present invention with a fixed feed network, it is possible to implement antenna elements with a wide radiation pattern in azimuth and/or elevation.

In a possible example embodiment of the three-dimensional antenna arrangement according to the present invention, the three-dimensional lattice has a face-centered cubic FCC lattice.

In the face-centered cubic (FCC) lattice, the antenna elements are located at the corners and in the center of each of the six faces of a cube of the three-dimensional lattice. Each antenna element on a face is shared with neighboring cubes of the lattice, which means that each antenna element on a face belongs to two cubes of the lattice.

The face-centered cubic FCC lattice is characterized by a high packing density so that a plurality of antenna elements can be accommodated in a certain volume of the three-dimensional antenna arrangement.

In a possible example embodiment of the three-dimensional antenna arrangement according to the present invention, the three-dimensional lattice has an HCP lattice.

In hexagonal closest packing (HCP) of spheres, the antenna elements are arranged in a hexagonal structure, in which each antenna element is surrounded by twelve other antenna elements. The antenna elements are stacked in two layers, namely a first hexagonal layer followed by a second hexagonal layer arranged to fill the gaps of the first layer.

The HCP lattice is likewise characterized by a high packing density so that a plurality of antenna elements can be accommodated in a certain volume of the three-dimensional antenna arrangement.

In a possible example embodiment of the three-dimensional antenna arrangement according to the present invention, the transmitting antenna elements and/or the receiving antenna elements form a tetrahedron, consisting of at least four antenna elements, in the three-dimensional lattice.

In a possible example embodiment of the three-dimensional antenna arrangement according to the present invention, the virtual antenna arrangement resulting from spatial convolution of the tetrahedral arrangement of the transmitting antenna elements and of the tetrahedral arrangement of the receiving antenna elements forms a Sierpinski tetrahedron.

A Sierpinski tetrahedron is a geometric figure created by repeatedly dividing and removing parts of a regular tetrahedron.

Despite its complex fractal antenna elements, the antenna arrangement according to the present invention in this embodiment can be easily produced since it is based on simple geometric rules. In one example embodiment of the present invention, the fractal antenna arrangement uses a Sierpinski triangle antenna based on the Sierpinski triangle fractal. This antenna arrangement is particularly useful in the field of telecommunications as well as in radar systems and satellite systems, where it is important to support multiple frequencies and to minimize the physical size of the antenna arrangement.

In a possible example embodiment of the three-dimensional antenna arrangement according to the present invention, the transmitting antenna elements and/or the receiving antenna elements are arranged rotated about one of the three spatial axes.

In a possible example embodiment of the three-dimensional antenna arrangement according to the present invention, the three-dimensional antenna arrangement has a three-dimensional MIMO (multiple-input multiple-output) antenna arrangement.

In a possible example embodiment of the three-dimensional antenna arrangement according to the present invention, a wave vector of the emitted waves and the received waves can be determined three-dimensionally by means of the virtual antenna arrangement.

According to a further aspect, the present invention also provides a radar device with a three-dimensional antenna arrangement with multiple transmitting antenna elements and multiple receiving antenna elements, wherein the transmitting antenna elements and the receiving antenna elements are arranged on a regular three-dimensional lattice and a virtual antenna arrangement of virtual antenna elements results from geometric convolution of an arrangement of the transmitting antenna elements and of an arrangement of the receiving antenna elements, wherein a phase difference of the virtual antenna elements of the virtual antenna arrangement is measurable in a third spatial dimension.

According to a further aspect, the present invention also provides a communication device with a three-dimensional antenna arrangement with multiple transmitting antenna elements and multiple receiving antenna elements, wherein the transmitting antenna elements and the receiving antenna elements are arranged on a regular three-dimensional lattice and a virtual antenna arrangement of virtual antenna elements results from geometric convolution of an arrangement of the transmitting antenna elements and of an arrangement of the receiving antenna elements, wherein a phase difference of the virtual antenna elements of the virtual antenna arrangement is measurable in a third spatial dimension.

The above example embodiments and developments of the present invention may be combined with one another in any reasonable manner. Further possible embodiments, developments and implementations of the present invention also include combinations not explicitly mentioned of features of the present invention described above or below with respect to the exemplary embodiments. A person skilled in the art will in particular also add individual aspects as improvements or additions to the relevant basic form of the present invention. The present invention is explained in more detail below on the basis of the exemplary embodiments indicated in the schematic figures.

### BRIEF DESCRIPTION OF THE DRAWINGS

FIG. 1A to 1D show wave vectors for different scenarios.

FIG. 2A to 2C show various possible lattices for placing antenna elements in a three-dimensional antenna arrangement, according to example embodiments of the present invention.

FIG. 3 shows a tetrahedron with four vertices for providing antenna elements.

FIG. 4A, 4B show a Sierpinski tetrahedron as a possible embodiment of a fractal arrangement of triangular antenna elements.

FIG. 5A, 5B show a Sierpinski tetrahedron as a possible embodiment of a fractal arrangement of cube-shaped antenna elements.

FIG. 5C shows a possible implementation of a signal feed of a fractal arrangement of antenna elements, according to an example embodiment of the present invention.

FIG. 6A to 6D show a planar MIMO array with four transmitting antenna elements and four receiving antenna elements.

FIG. 7A to 7C show a virtual group factor for a square arrangement of the antenna elements.

FIG. 8A to 8C show a virtual group factor with increased element distance between the antenna elements.

FIG. 9A to 9D show a fractal MIMO array with four transmitting antenna elements and four receiving antenna elements according to an example embodiment of the antenna arrangement according to the present invention, resulting from shifting two transmitting antenna elements and two receiving antenna elements of the planar MIMO array in the z direction.

FIG. 10A to 10C show a virtual group factor of the fractal antenna arrangement shown in FIG. 9.

FIG. 11A to 11C show a virtual group factor at an increased element distance between the antenna elements in the fractal antenna arrangement shown in FIG. 9.

FIG. 12A to 12D show a further possible embodiment of an antenna arrangement according to the present invention implemented by rotating the fractal antenna arrangement shown in FIG. 9.

FIG. 13A to 13C show a virtual group factor of the fractal antenna arrangement shown in FIG. 12.

FIG. 14A to 14C show a virtual group factor of the fractal antenna arrangement, shown in FIG. 12, in another plane.

FIG. 15A to 15C show a virtual group factor at an increased element distance between the antenna elements in the fractal antenna arrangement shown in FIG. 12.

FIG. 16A, 16B show an optimal regular sampling lattice as can be used in the antenna arrangement according to the present invention, and an associated reciprocal lattice in the 3D spatial frequency domain.

FIG. 17A to 17F show a planar arrangement of antenna elements and a fractal Sierpinski tetrahedron arrangement of antenna elements according to a possible embodiment of the antenna arrangement according to the present invention.

FIG. 18A to 18F show further representations of possible antenna element arrangements for explaining a possible embodiment of the antenna arrangement according to the present invention.

FIG. 19A to 19C show a combination of a basic arrangement for explaining an antenna arrangement according to the present invention.

FIG. 20A to 20C show further variants of possible antenna element arrangements, according to the present invention.

FIG. 21A to 21C show a combination of a basic arrangement for explaining an antenna arrangement according to the present invention.

FIG. 22A, 22B show possible exemplary embodiments of the fractal 3D MIMO antenna arrangement shown in FIG. 18, according to the present invention.

FIG. 23 is a schematic representation of a device having a three-dimensional antenna arrangement according to an example embodiment of the present invention.

### DETAILED DESCRIPTION OF EXAMPLE EMBODIMENTS

The figures are intended to impart further understanding of the example embodiments of the present invention. They illustrate embodiments and, in connection with the description, serve to explain principles and concepts of the present invention. Other embodiments and many of the mentioned advantages are apparent from the figures. The elements of the figures are not necessarily shown to scale relative to one another.

In the figures, identical, functionally identical, and identically acting elements, features and components are provided with the same reference signs in each case, unless stated otherwise.

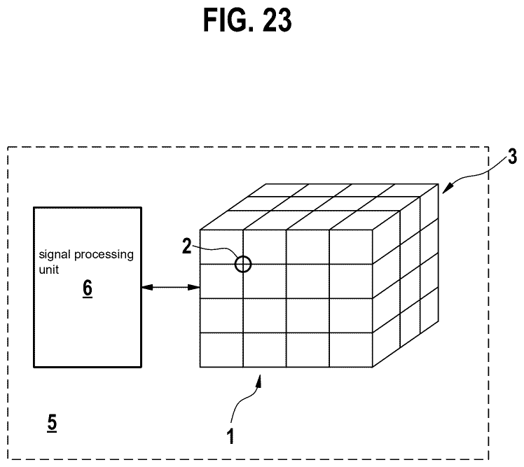

According to a first aspect, the present invention provides a three-dimensional antenna arrangement 1 with antenna elements 2. The three-dimensional antenna arrangement 1 can be provided in a device 5 as shown schematically in FIG. 23.

The antenna elements 2 of the antenna arrangement 1 comprise transmitting antenna elements 2A and receiving antenna elements 2B. The transmitting antenna elements 2A and the receiving antenna elements 2B are arranged on a regular three-dimensional lattice 3. A virtual antenna arrangement of virtual antenna elements 4 results from geometric convolution of an arrangement of the transmitting antenna elements 2A and of an arrangement of the receiving antenna elements 2B. A phase difference of the virtual antenna elements 4 of the virtual antenna arrangement, which comprises the virtual antenna elements 4, is measurable in a third spatial dimension and can be evaluated by a signal processing unit 6 of the device 5.

A 3D MIMO arrangement of the antenna elements 2 makes it possible to measure the phase difference of the antenna elements 4 of the virtual antenna arrangement in an additional third spatial dimension. As a result, the wave vector of the transmitted and received waves can also be determined in three dimensions.

The antenna arrangement 1 according to the present invention also makes it possible to achieve a constant angular resolution over a very wide angular range in azimuth and/or elevation (>180°) due to the three-dimensional arrangement of the transmitting antenna elements 2A and the receiving antenna elements 2B.

The three-dimensional antenna arrangement 1 according to the present invention allows for unambiguous classification and filtering of ambiguities, which in turn makes it possible to increase the element distance between antenna elements 2. As a result, it is possible with the same number of transmitting antenna elements 2A and receiving antenna elements 2B to improve the angular resolution of a MIMO radar device or any other device that processes the received signals of the three-dimensional antenna arrangement 1.

At the same time, the approach according to the present invention can be used to distinguish and filter direct paths from multipath paths with different transmission and reception directions, whereby ghost targets are reduced.

In a possible embodiment of the three-dimensional antenna arrangement 1 according to the present invention, the transmitting antenna elements 2A and the receiving antenna elements 2B each have a fractal arrangement of the antenna elements.

The three-dimensional fractal arrangement of antenna elements 2 on an optimal regular lattice 3 maximizes the distance between the ambiguities for a given number of transmitting antenna elements 2A and receiving antenna elements 2B. At the same time, coupling and mutual shading of the antenna elements 2 is avoided.

In a possible embodiment, the fractal arrangement of the antenna elements 2 makes it possible to implement the three-dimensional arrangement of the antenna elements 2 in a simple manner on the basis of a planar antenna arrangement with attached linear waveguides, which can inter alia be implemented in waveguide technology.

In addition, in a possible embodiment with a fixed feed network, antenna elements 2 with a wide radiation pattern in azimuth and/or elevation can be implemented.

In a possible embodiment of the three-dimensional antenna arrangement 1 according to the present invention, the three-dimensional lattice 3 has a face-centered cubic FCC lattice.

In a possible embodiment of the three-dimensional antenna arrangement 1 according to the present invention, the three-dimensional lattice 3 has an HCP lattice.

In a possible embodiment of the three-dimensional antenna arrangement 1 according to the present invention, the transmitting antenna elements 2A and/or the receiving antenna elements 2B form a tetrahedron, consisting of at least four antenna elements 2, in the three-dimensional lattice 3.

In a possible embodiment of the three-dimensional antenna arrangement 1 according to the present invention, the from [sic]¹ spatial convolution of the tetrahedral arrangement of the transmitting antenna elements 2A and of the tetrahedral forms a Sierpinski tetrahedron. ¹ [Translator's note: The original German sentence is garbled. Compare similar sentence on page 5, lines 12-17.]

A Sierpinski tetrahedron is a geometric figure created by repeatedly dividing and removing parts of a regular tetrahedron. The Sierpinski tetrahedron can be constructed and implemented as follows.

The start is a regular tetrahedron consisting of four equilateral triangles.

Each of the four equilateral triangles of the tetrahedron is divided into four smaller equilateral triangles by halving one edge of each and connecting the new vertices. This results in a total of 4*4=16 smaller triangles.

The above step is repeated for each of the newly created triangles by dividing each into four smaller triangles. This results in ever smaller and more detailed versions of the original tetrahedron.

After multiple iterations, a pattern called the Sierpinski tetrahedron emerges. It is a self-similar fractal with a three-dimensional tetrahedron structure, in which each smaller tetrahedron is a scaled-down version of the original tetrahedron.

In a possible embodiment of the three-dimensional antenna arrangement 1 according to the present invention, the transmitting antenna elements 2A and/or the receiving antenna elements 2B are arranged rotated about one of the three spatial axes.

In a possible embodiment of the three-dimensional antenna arrangement 1 according to the present invention, the three-dimensional antenna arrangement has a three-dimensional MIMO antenna arrangement.

In a possible embodiment of the three-dimensional antenna arrangement 1 according to the present invention, a wave vector of the emitted waves and the received waves can be determined three-dimensionally by means of the antenna elements 4 of the virtual antenna arrangement.

According to a further aspect, the present invention also provides a radar device with a three-dimensional antenna arrangement 1 with multiple transmitting antenna elements 2A and multiple receiving antenna elements 2B, wherein the transmitting antenna elements 2A and the receiving antenna elements 2B are arranged on a regular three-dimensional lattice 3 and a virtual antenna arrangement of virtual antenna elements 4 results from geometric convolution of an arrangement of the transmitting antenna elements 2A and of an arrangement of the receiving antenna elements 2B, wherein a phase difference of the virtual antenna elements 3 of the virtual antenna arrangement is measurable in a third spatial dimension.

According to a further aspect, the present invention also provides a communication device with a three-dimensional antenna arrangement 1 with multiple transmitting antenna elements 2A and multiple receiving antenna elements 2B, wherein the transmitting antenna elements 2A and the receiving antenna elements 2B are arranged on a regular three-dimensional lattice 3 and a virtual antenna arrangement of virtual antenna elements 4 results from geometric convolution of an arrangement of the transmitting antenna elements 2A and of an arrangement of the receiving antenna elements 2B, wherein a phase difference of the virtual antenna elements 4 of the virtual antenna arrangement is measurable in a third spatial dimension.

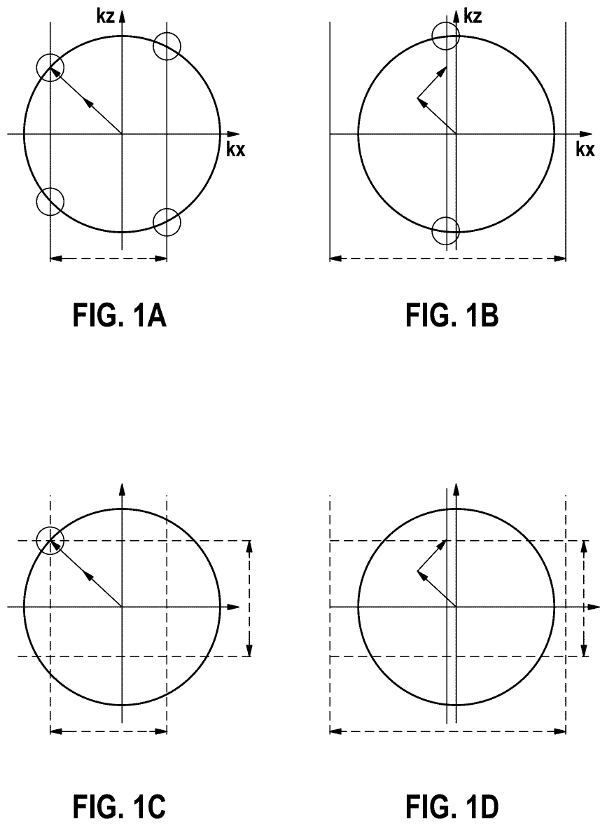

FIG. 1A shows wave vectors WV (TX-WV and RX-WV) for a conventional planar MIMO antenna arrangement with ambiguities. FIG. 1B shows wave vectors WV for an asymmetric multipath propagation.

FIG. 1C shows wave vectors for a 3D MIMO antenna arrangement. FIG. 1D shows wave vectors for an asymmetric multipath propagation.

According to FIG. 1A to FIG. 1D, the wave vectors WV of the direct paths lie on a spherical shell with the radius of twice the wave number.

The planar antenna arrangement measures the projection of the wave vector WV in the plane, which makes it impossible to resolve the 2D periodic ambiguities.

The three-dimensional antenna arrangement 1 according to the present invention, on the other hand, can unambiguously resolve the 3D periodic ambiguities if they do not lie on the spherical shell. Since the pattern of the ambiguities is known and the periodicity exists in the Cartesian spatial directions, ambiguities on the hemispherical shell can also be resolved unambiguously. This allows a significantly larger distance between the antenna elements 2, which can improve the angular resolution.

For multipath paths with different transmission and reception directions, the wave number vectors are not parallel to one another, as can be seen in FIG. 1B and FIG. 1D, so that these paths lie within the hemisphere and can thus be identified. This method is significantly more robust than multipath estimation based on the amplitude ratios of the directional characteristics.

For filtering the ambiguities and asymmetric multipath paths, the three-dimensional spatial frequency spectrum can be calculated by means of a 3D FFT of the ZF signals based on the virtual antenna positions, and the hemispherical shell can be evaluated for any azimuth and elevation directions. This form of beamforming can be efficiently implemented in azimuth and elevation by means of a NUFFT directly onto any lattice. Alternatively, an angle estimation can also be carried out after the range Doppler processing, which takes the additional spatial frequency dimension into account.

The fast Fourier transform (FFT) is an efficient algorithm for calculating the discrete Fourier transform (DFT) and its inverse. A 3D FFT extends this algorithm to three-dimensional data, which means that the Fourier transform is performed along all three spatial dimensions. Zero-frequency (ZF) or intermediate-frequency (IF) signals are signals that are downconverted from a high carrier frequency to a lower, manageable frequency.

For calculating a three-dimensional spatial frequency spectrum, the following steps can be carried out in a possible implementation of the device according to the present invention. First, three-dimensional ZF signals are collected, which originate from antenna elements 2 arranged in a lattice 3 of points in the three spatial dimensions (x, y, z). If necessary, the obtained ZF signals can be processed in order to reduce noise or to normalize the data. A 3D FFT is applied to the 3D data in order to calculate the frequency spectrum in all three dimensions. This transforms the data from the position space (spatial position) into the frequency space (spatial frequencies). For each voxel (volume pixel) in the 3D space, a Fourier transform can be calculated, which decomposes the signal into a sum of sine and cosine components. The resulting three-dimensional frequency spectrum shows the distribution of the frequency components of the original signal in all three spatial dimensions. This spectrum can be used to identify features in the original 3D data space. The signal processing can be carried out by a processor or an ASIC of a signal processing unit 6 of a device 5, as shown schematically in FIG. 23.

In a possible embodiment of the antenna arrangement 1 according to the present invention, the concept of a fractal antenna arrangement can be extended to three dimensions in order to additionally measure the phase difference in a third spatial dimension.

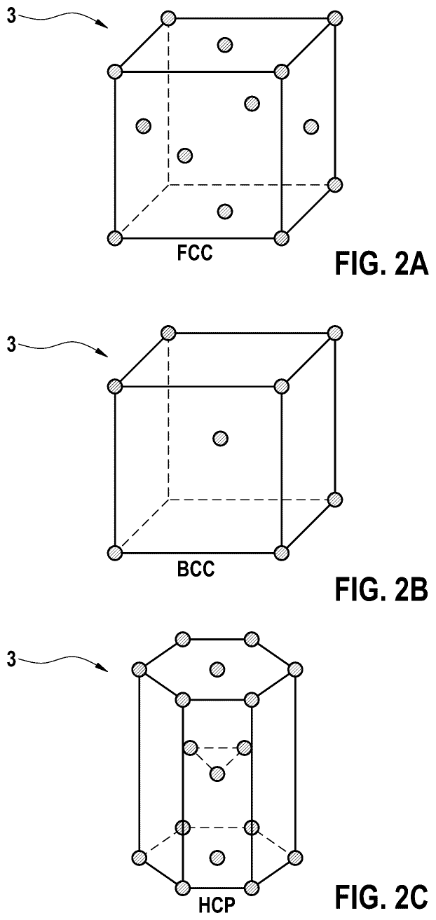

Preferably, a regular three-dimensional lattice 3 is used here. This lattice 3 preferably has the closest possible sphere packing in order to maximize the distance between the ambiguities in the spatial frequency domain of the arrangement. In a possible embodiment, this property is fulfilled by a face-centered cubic (FCC) lattice, as shown in FIG. 2A, or by a hexagonal closest packing (HCP) of spheres, as shown in FIG. 2C. Depending on the application and available space, other three-dimensional lattice structures can also be used.

Both lattices 3 shown in FIG. 2A, 2C are closely related and generate an arrangement of ambiguities in the spatial frequency domain according to their reciprocal lattice, the body-centered cubic (BCC) lattice, as shown in FIG. 2C.

Analogously to a triangular arrangement in 2D (2-simplex), a basic arrangement of four antenna elements 2 in the form of the vertices of a tetrahedron (3-simplex) can be used in the three-dimensional antenna arrangement 1 according to the present invention. For this purpose, the antenna elements 2 are arranged on an FCC lattice (FIG. 2A) or on an HCP lattice (FIG. 2C), all antenna elements 2 preferably having the same distance from one another.

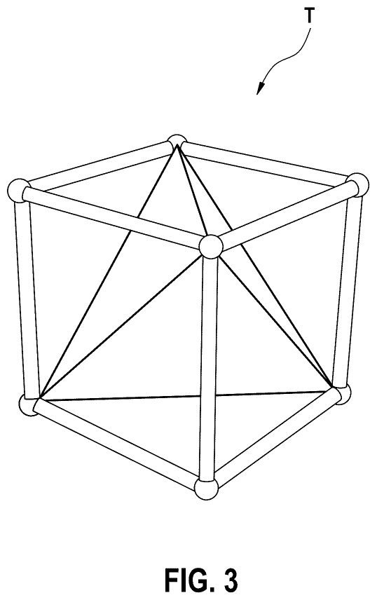

The tetrahedron T shown in FIG. 3 with 2²=4 can be considered as an efficient subset of the equidistant sampling cube with 2³=8 vertices.

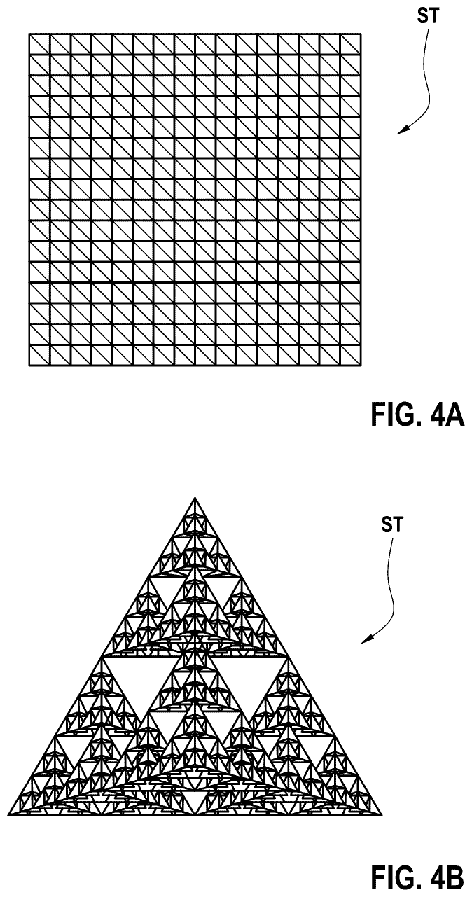

Through self-similar arrangement of the tetrahedron arrangement, larger arrangements with 4n antenna elements in the form of the Sierpiński tetrahedron ST can be generated, as shown in FIG. 4A, 4B. This self-similar or fractal arrangement of the antenna elements 2 also lies on the FCC lattice or the HCP lattice. As with the tetrahedron T shown in FIG. 3, the arrangement has the unique property that the projections on three orthogonal Cartesian axes correspond to a square arrangement with a square lattice with 4n elements. A Sierpiński tetrahedron ST with two projection views results in a square arrangement for the Cartesian principal axes.

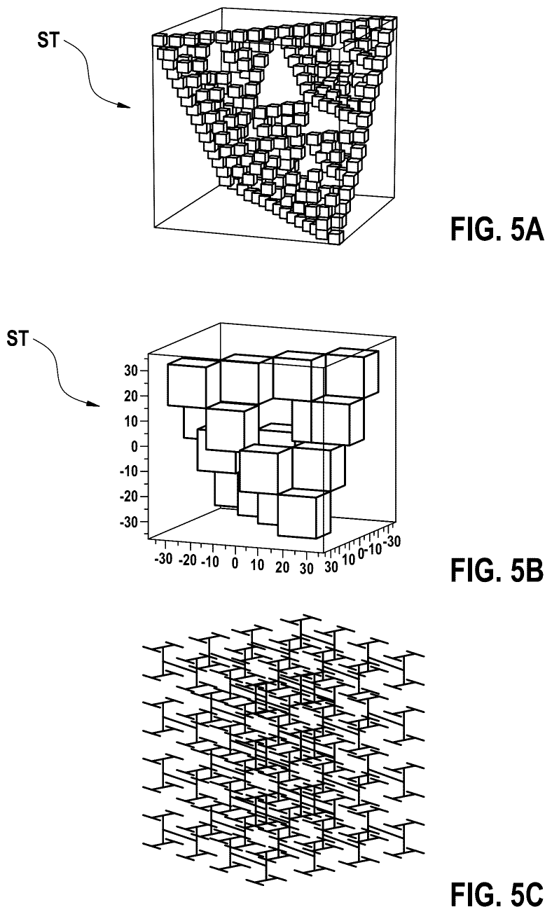

Here, each tetrahedron corresponds to an antenna element arrangement as shown in FIG. 4A, 4B. The angular resolution and also the side lobe pattern of the fractal antenna arrangement thus correspond to this square arrangement. The arrangement in the form of the Sierpiński tetrahedron ST thus extends the square arrangement with 2ⁿ*2ⁿ elements into the third dimension and thereby implements an optimal thinned spatial sampling of a cube 2ⁿ*2ⁿ*2ⁿ with only 2ⁿ*2ⁿ antenna elements. FIG. 5A, 5B show a Sierpiński tetrahedron ST with cubes (FIG. 5B) instead of triangles (FIG. 5A).

This property also allows implementation by extending a planar group antenna with attached straight waveguides, such as cylindrical waveguides in the form of a milled plate with holes of different depths or a metallized injection-molded component. Alternatively, the feeding can also be carried out in the form of an H-tree fractal with twisted branches, as shown in FIG. 5C.

The virtual MIMO arrangement is generated from the transmitting and receiving arrangements by convolution. Here, too, by appropriate scaling of the element distances, arrangements in the form of a Sierpiński tetrahedron ST with 4ⁿ transmitting elements and 4^{m} receiving elements can be combined to form a Sierpiński tetrahedron with 4^{(n+m)} virtual antenna positions. Furthermore, the fractal arrangements can be combined as subgroups with conventional planar arrangements in order to obtain additional degrees of freedom in the design.

A possible procedure for generating the Sierpiński tetrahedral antenna arrangement is as follows:
providing a first tetrahedron arrangement with four antenna elements having a distance d.
providing a second tetrahedron arrangement with four antenna elements with a scaled distance d√4=2d.
performing a spatial convolution of both tetrahedron arrangements to form a Sierpiński tetrahedron (ST) with 4*4=16 antenna elements.

This can be generalized as follows:
providing a first Sierpiński tetrahedron with 4ⁿ elements and a distance d.
providing a second Sierpiński tetrahedron with 4^{m} elements and distance d√4.
performing a spatial convolution of both arrangements to form a Sierpiński tetrahedron ST with 4^{(n+m)} elements and distance d.

Further variants of the antenna arrangement 1 according to the present invention result from an optional rotation by 90° (about the x-, y- or z-axis) when combining the arrangements. Through the optional rotation, alternative 3D fractal arrangements can be generated for each combination, which arrangements, however, have the same projection properties as the Sierpiński tetrahedron ST and have the Hausdorff dimension 2.

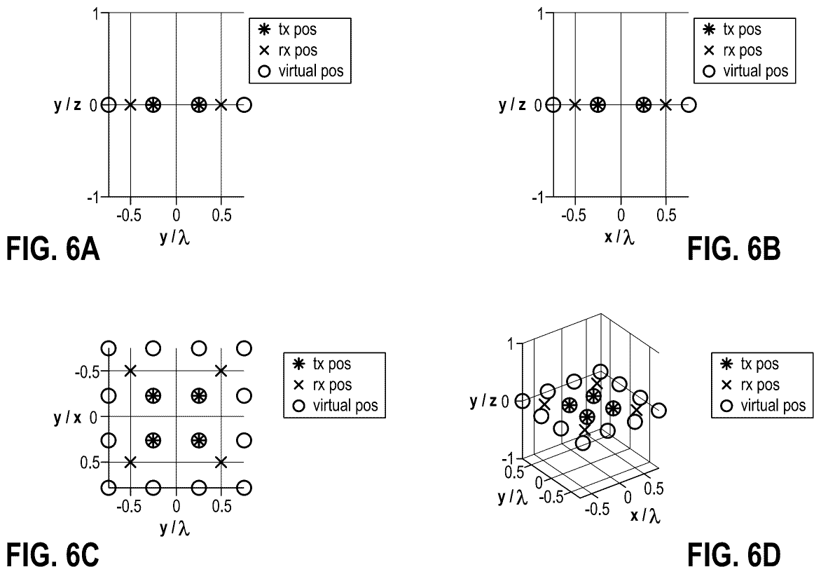

FIG. 6A to 6D show a planar MIMO array with four transmitting and four receiving elements with a 0.5λ element distance. The positions of the transmitting antenna elements 2A (tx pos), the receiving antenna elements 2B (rx pos), and the virtual antenna elements 4 (virtual pos) can be seen.

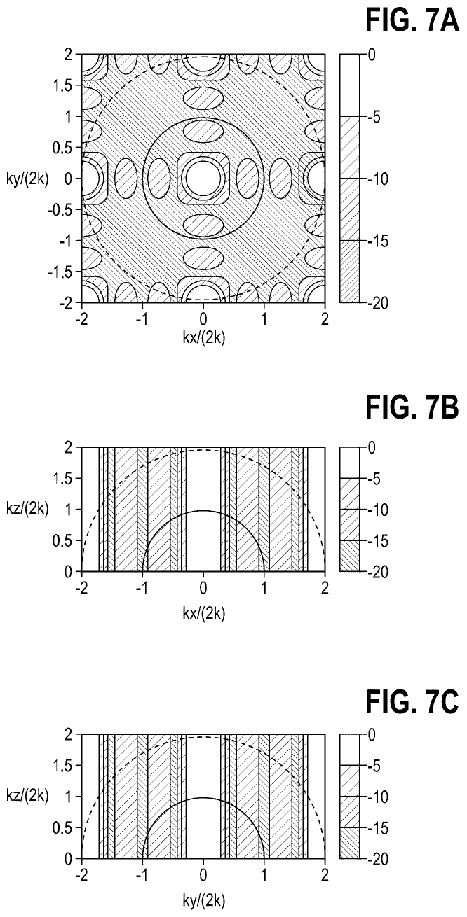

FIG. 7A, 7B, 7C illustrate a virtual group factor GF of the square arrangement for a target at elevation 0° and azimuth 0°. The group factor has no resolution in the kz direction. The angular resolution deteriorates with increasing azimuth and elevation angle due to the plane aperture. The unambiguous range is 2k in the kx and ky directions and thus makes unambiguous angle determination possible.

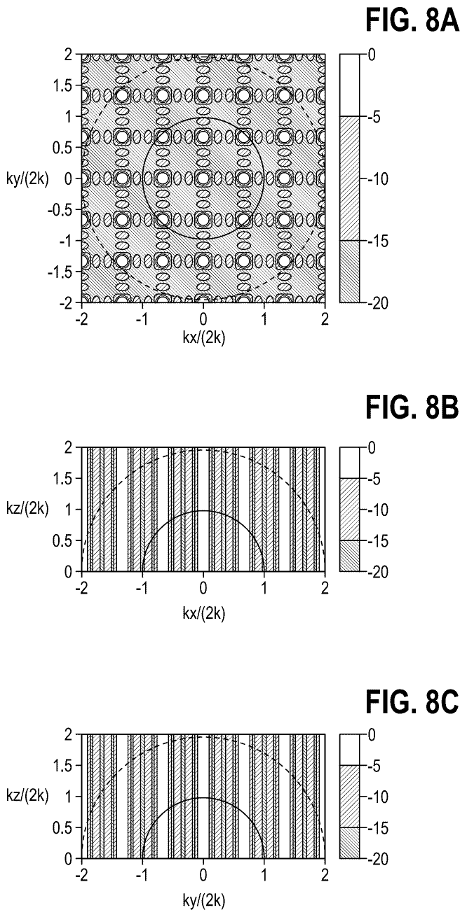

If the element distance is increased to 1.5λ, the ambiguities within the hemisphere with radius 2k can no longer be resolved, as can be seen in FIG. 8A, 8B, 8C. In the kx-ky plane, it becomes clear that there are now eight ambiguities within the hemisphere.

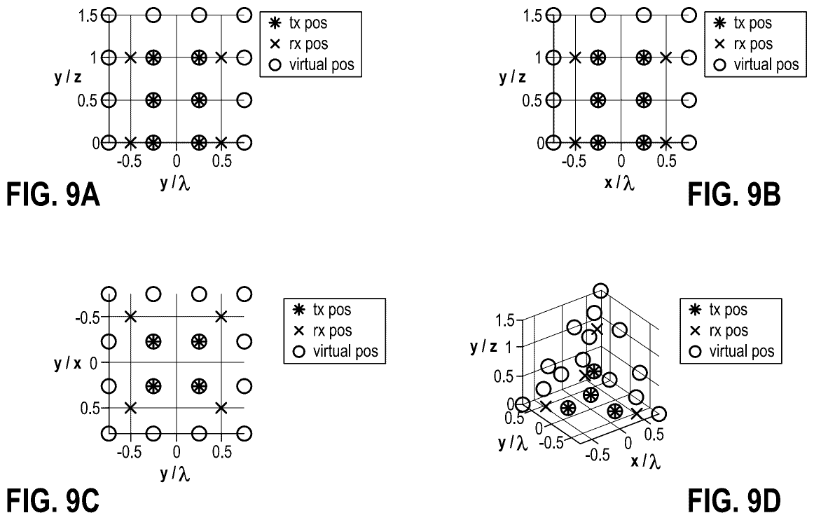

FIG. 9A to 9D show a fractal MIMO array 1 with four transmitting antenna elements and four receiving antenna elements by shifting two transmitting and two receiving elements of the planar array in the z direction. The positions of the transmitting antenna elements 2A (tx pos), the receiving antenna elements 2B (rx pos), and the virtual antenna elements 4 (virtual pos) can be seen.

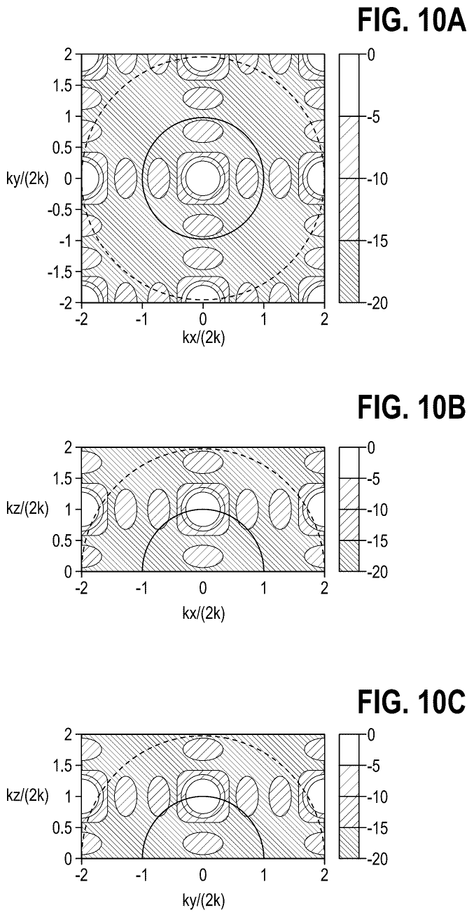

FIG. 10A, 10B, 10C show the virtual group factor GF of the fractal antenna arrangement for a target at elevation 0° and azimuth 0° (kx=0, ky=0, kz=2k).

The group factor has an identical resolution in the kx, ky, and kz directions. The angular resolution is thus constant for all directions and is identical to the minimum resolution of the planar arrangement with the same number of antenna elements. The distance between the ambiguities is also identical in the kx, ky, and kz directions and is 2k.

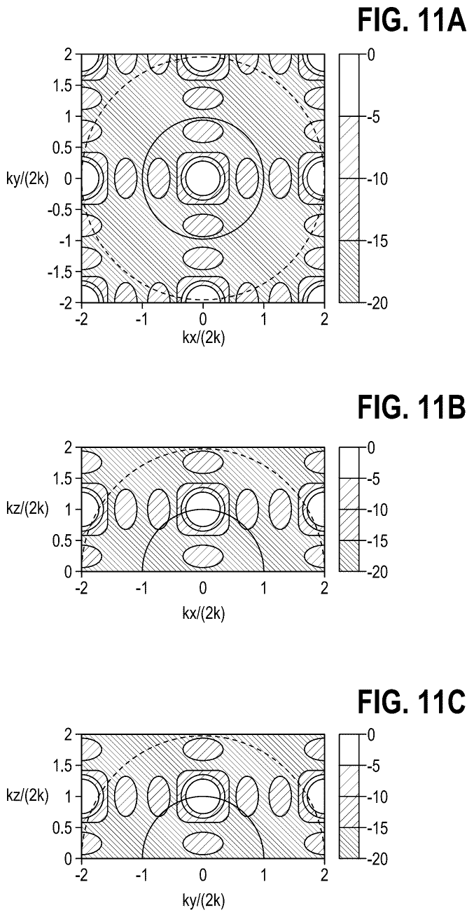

If the element distance is increased to 1.5λ, the ambiguities within the hemisphere with radius 2k can be filtered out on the basis of the kz component, as can be seen in FIG. 11A, 11B, 11C.

The angular resolution is improved by scaling in azimuth and elevation by a factor 3. Ambiguities that partially intersect the hemispherical shell 2k reduce the side lobe spacing of the virtual group factor. Here, too, the better angular resolution is therefore achieved with the trade-off of worse side lobe spacing. Compared with the planar square arrangement, however, the ratio is significantly better for the fractal 3D antenna arrangement 1 since point-like ambiguities must intersect the hemispherical shell 2k here. In the planar arrangement, the linear ambiguities always intersect the hemispherical shell if the element distance is greater than 0.5λ.

An alternative implementation can be achieved by rotating the fractal antenna arrangement. Now three of the four elements lie in the z=0 plane and only the relevant element at x=y=0 rises out of the plane.

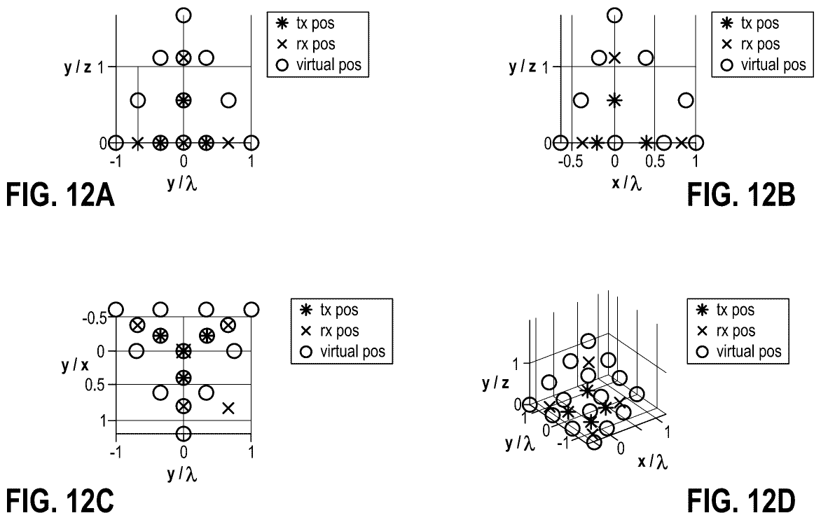

For better decoupling of the transmitting and receiving arrangements, they can also be shifted relative to one another without fundamentally changing the virtual arrangement, as shown in FIG. 12A to 12D. The positions of the transmitting antenna elements 2A (tx pos), the receiving antenna elements 2B (rx pos), and the virtual antenna elements 4 (virtual pos) can be seen.

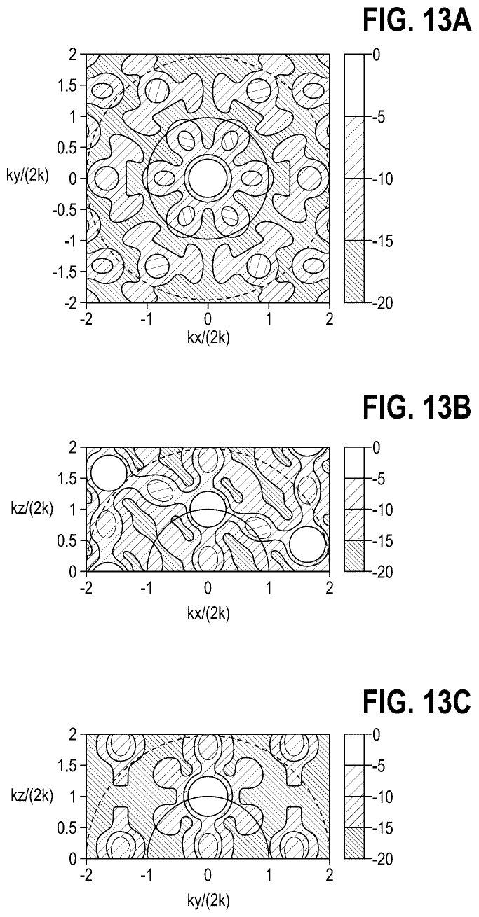

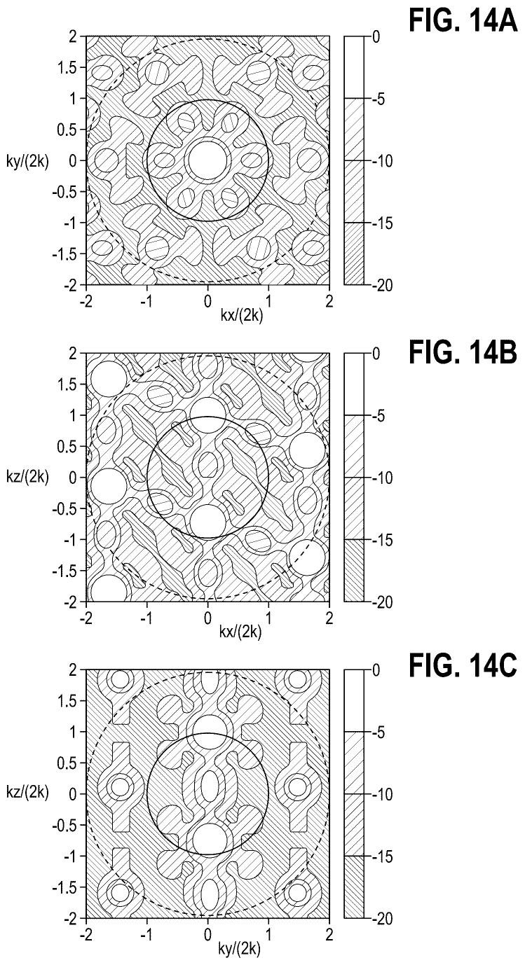

FIG. 13A, 13B, 13C show the virtual group factor GF of the rotated antenna arrangement 1 at an element distance of 0.5λ. In general, in the 3D arrangements, the entire sphere 2k can also be evaluated if the corresponding antenna elements 2 have a radiation range >180° in azimuth and/or elevation. The 3D phase evaluation also makes it possible here to unambiguously distinguish between the positive and negative kz components as can be seen in FIG. 14A, 14B, 14C.

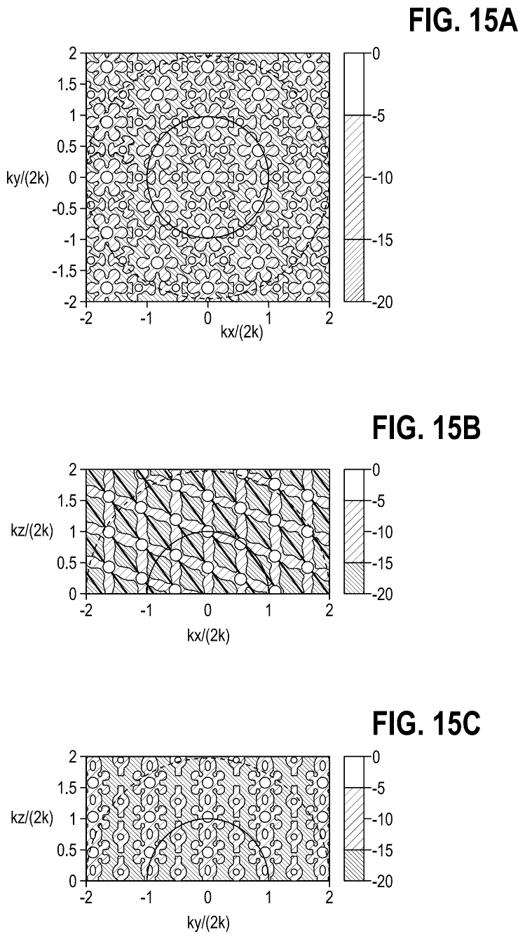

FIG. 15A, 15B, 15C show a virtual group factor GF of the rotated antenna arrangement 1 at an element distance of 1.5λ. What can be seen here in the kz=0 plane and the ky=0 plane is a hexagonal arrangement of the ambiguities. In the kx=0 plane, the ambiguities are present in the form of a rectangular lattice.

Overall, what can be seen for the fractal virtual group factor GF are section planes of the ambiguities of the BCC lattice, which maximizes the distance between the ambiguities and thus represents an optimum.

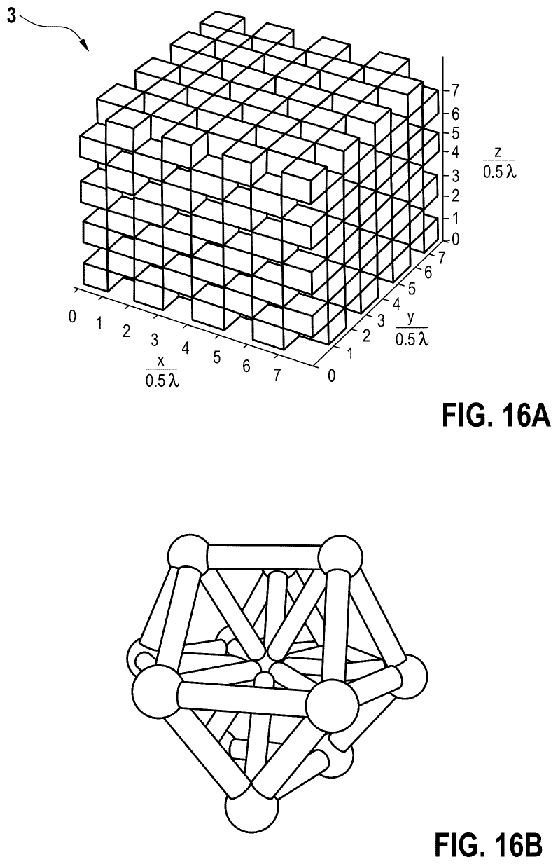

FIG. 16A, 16B show an optimal regular sampling lattice as can be used in the antenna arrangement 1 according to the present invention, and an associated reciprocal lattice in the 3D spatial frequency domain.

FIG. 16A shows an optimal regular sampling lattice in 3D. The face-centered cubic (FCC) lattice 3 shown in FIG. 16A corresponds to the closest packing of spheres.

FIG. 16B shows a reciprocal lattice in the 3D spatial frequency domain, which corresponds to a body-centered cubic (BCC) lattice as shown in FIG. 2B. The distance between the six nearest lattice lobes is identical and therefore maximum.

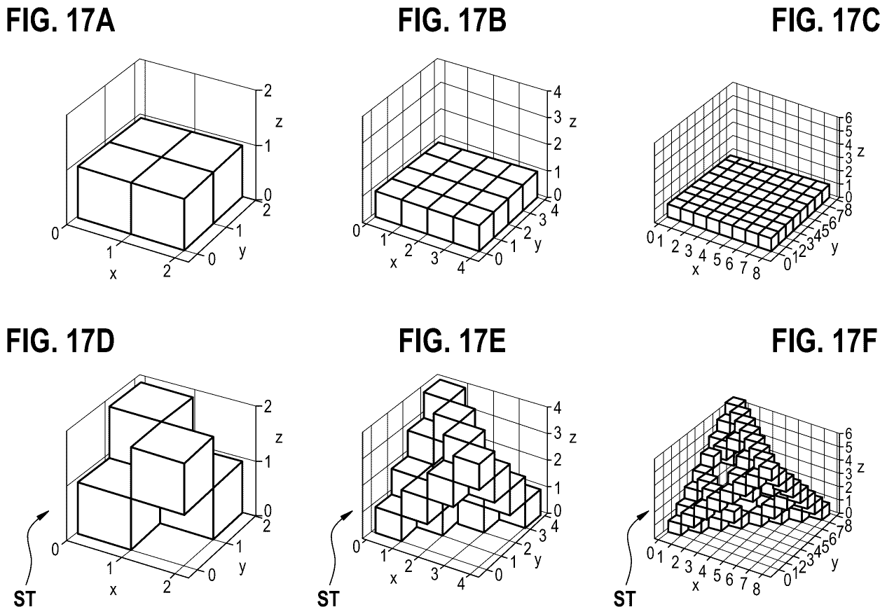

FIG. 17A to 17F show a planar arrangement of antenna elements (FIG. 17A to 17C) and a fractal Sierpinski tetrahedron arrangement (FIG. 17C to 17F) of antenna elements according to a possible embodiment of the antenna arrangement 1 according to the present invention.

The Sierpiński tetrahedron ST implements a sparse sampling of the FCC lattice. The orthogonal projections (x, y, z) correspond to the planar square arrangement. Mutual shading is minimized. Since each antenna element 2 is visible from the six orthogonal directions, the antenna arrangement 1 according to the present invention thus has an advantage over a conventional conformal antenna arrangement with regard to mutual shading perpendicular to the main beam direction.

FIG. 17A shows a square planar arrangement with four antenna elements.

FIG. 17B shows a square planar arrangement with sixteen antenna elements.

FIG. 17C shows a square planar arrangement with sixty-four antenna elements.

FIG. 17D shows a first-order Sierpinski tetrahedron ST with four antenna elements 2 for illustrating a possible embodiment of the antenna arrangement 1 according to the present invention.

FIG. 17E shows a second-order Sierpinski tetrahedron ST with sixteen antenna elements 2 for illustrating a possible embodiment of the antenna arrangement 1 according to the present invention.

FIG. 17F shows a third-order Sierpinski tetrahedron ST with sixty-four antenna elements 2 for illustrating a possible embodiment of the antenna arrangement 1 according to the present invention.

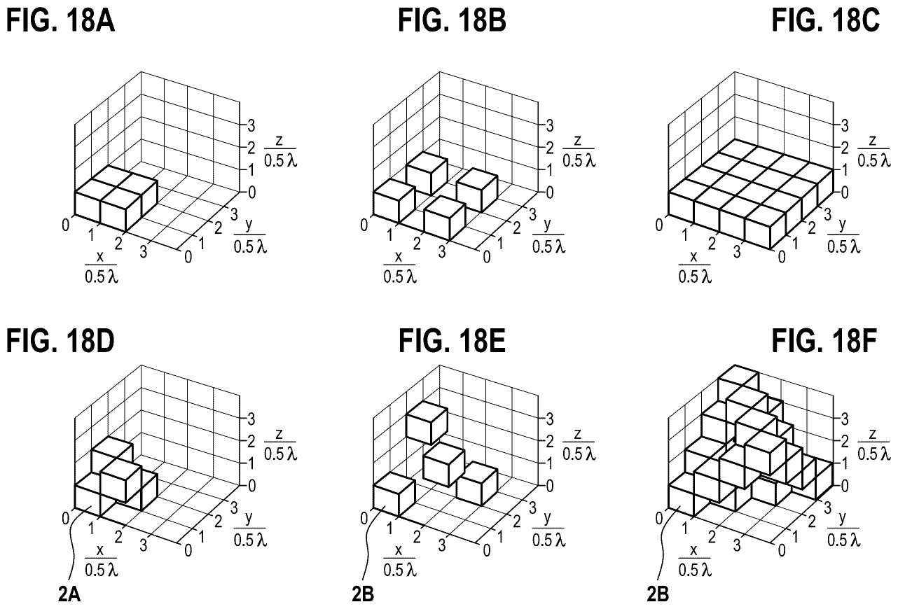

FIG. 18A to 18F show further representations of possible antenna element arrangements for explaining a possible embodiment of the antenna arrangement 1 according to the present invention.

FIG. 18A shows a planar arrangement of four transmitting antenna elements.

FIG. 18B shows a planar arrangement of four receiving antenna elements.

FIG. 18C shows a planar arrangement of 16 virtual antenna elements, which result from spatial convolution of the real antenna elements shown in FIGS. 18A and 18B.

FIG. 18D shows a three-dimensional arrangement of four transmitting antenna elements 2A of a transmitting antenna array.

FIG. 18E shows a three-dimensional arrangement of four receiving antenna elements 2B of a receiving antenna array.

FIG. 18F shows a three-dimensional arrangement of sixteen virtual antenna elements 4, which result from spatial convolution of the real antenna elements 2A, 2B shown in FIGS. 18D and 18E, for illustrating a possible embodiment of a three-dimensional antenna arrangement 1 according to the present invention.

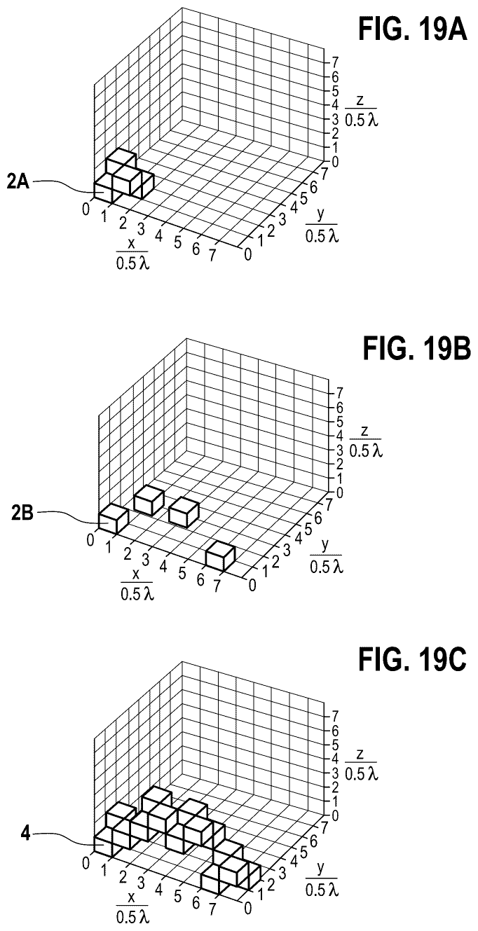

FIG. 19A to 19C show a combination of a basic arrangement for explaining an antenna arrangement according to the present invention. FIG. 19A to 19C show a combination of the basic arrangement with a conformal Rx arrangement for better resolution in azimuth (x direction) and main beam direction in the z direction.

FIG. 19A shows an arrangement of four transmitting antenna elements 2A in a 3D transmitting antenna array.

FIG. 19B shows an arrangement of four receiving antenna elements 2B in a 3D receiving antenna array.

FIG. 19C shows a 3D virtual antenna array with sixteen virtual antenna elements 4 for illustrating a possible embodiment of a three-dimensional antenna arrangement 1 according to the present invention.

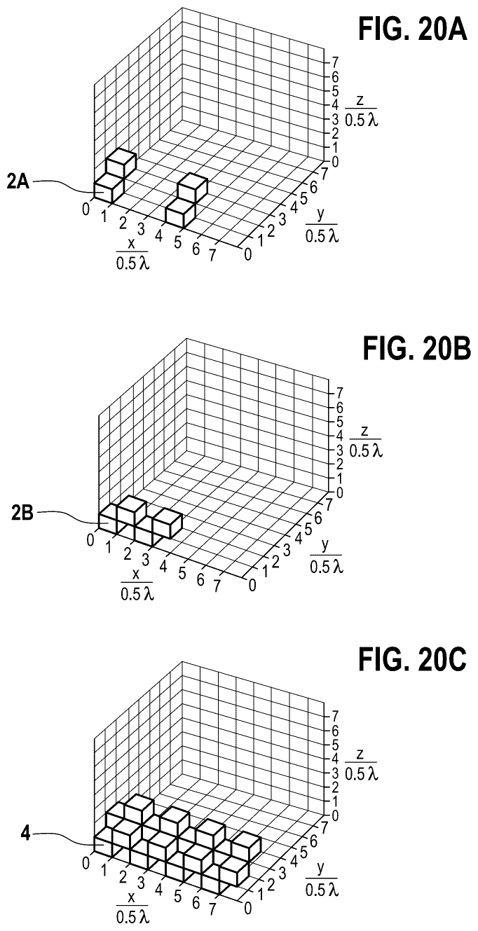

FIG. 20A to 20C show further variants of possible antenna element arrangements.

FIG. 20A shows an arrangement of four transmitting antenna elements 2A in a 3D transmitting antenna array.

FIG. 20B shows an arrangement of four receiving antenna elements 2B in a 3D receiving antenna array.

FIG. 20C shows a 3D virtual antenna array with sixteen virtual antenna elements 4 for illustrating a possible embodiment of a three-dimensional antenna arrangement 1 according to the present invention. A variant with a planar Rx arrangement and better resolution in azimuth (x direction) can be seen, with the main beam direction being in the y direction.

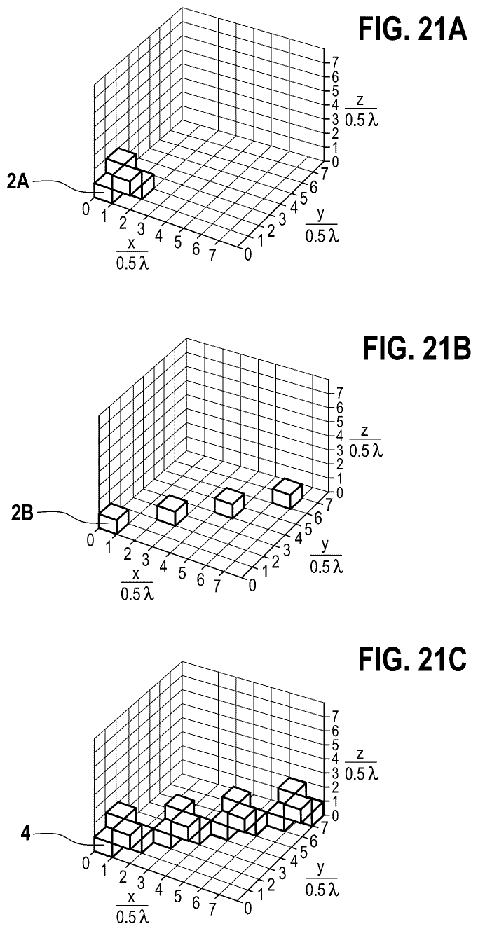

FIG. 21A to 21C show a combination of a basic arrangement for explaining an antenna arrangement 1 according to the present invention. A combination of the basic arrangement with linear Rx arrangement in diagonal alignment, better resolution in azimuth (x=y diagonal) can be seen, with the main beam direction being in the z direction.

FIG. 21A shows an arrangement of four transmitting antenna elements 2A in a 3D transmitting antenna array.

FIG. 21B shows an arrangement of four receiving antenna elements 2B in a 3D receiving antenna array.

FIG. 21C shows a 3D virtual antenna array with sixteen virtual antenna elements 4 for illustrating a possible embodiment of a three-dimensional antenna arrangement 1 according to the present invention.

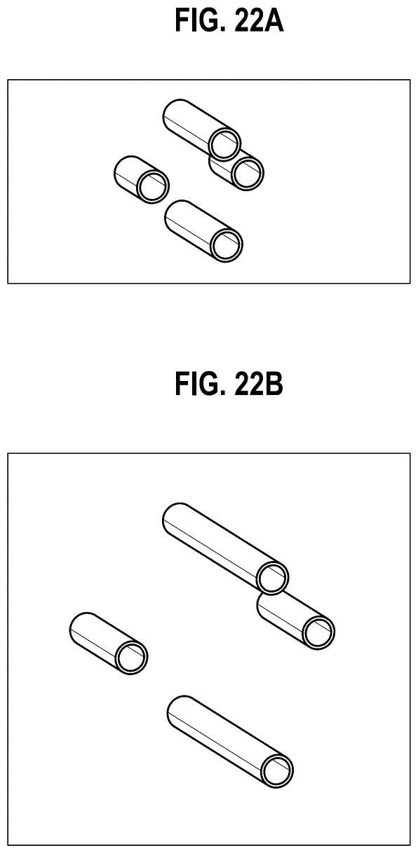

FIG. 22A, 22B show possible exemplary embodiments of the fractal 3D MIMO antenna arrangement shown in FIG. 18.

FIG. 22A, 22B show an implementation example of the fractal 3D MIMO antenna arrangement 1 of FIG. 18 with linear cylindrical waveguides fed from the xy plane. The transmitting arrangement (top) and the receiving arrangement (bottom) can be arranged one above the other (elevation plane) for better decoupling and less mutual shading.

Feeding can be carried out from the plane by attaching additional waveguides. The attached waveguide structure can also be integrated, e.g., as a partially metallized injection-molded part.

FIG. 23 schematically shows a device 5 with an integrated three-dimensional antenna arrangement 1, in which antenna elements 2 are provided in a three-dimensional lattice 3. The device 5 has a signal processing unit 6 for processing the signals received by the antenna arrangement 1 and for providing the signals emitted by the antenna arrangement 1. In a possible embodiment, the three-dimensional antenna arrangement 1 is integrated into a housing of the device 5. Alternatively, the three-dimensional antenna arrangement 1 can be connected to the signal processing unit 6 via an interface.

The device 5 shown in FIG. 23 may be a mobile device, for example a mobile communication device, in particular a mobile telephone device (mobile phone). The device 5 may also be a radar device or another device that emits and/or receives signals via antenna elements.

Although the present invention has been completely described above with reference to preferred exemplary embodiments, it is not limited thereto, but can be modified in many ways.

What is claimed is:

1. A three-dimensional antenna arrangement, comprising:
multiple transmitting antenna elements and multiple receiving antenna elements, wherein the transmitting antenna elements and the receiving antenna elements are arranged on a regular three-dimensional lattice, and a virtual antenna arrangement of virtual antenna elements results from geometric convolution of an arrangement of the transmitting antenna elements and of an arrangement of the receiving antenna elements, wherein a phase difference of the virtual antenna elements of the virtual antenna arrangement is measurable in a third spatial dimension.

2. The three-dimensional antenna arrangement according to claim 1, wherein the transmitting antenna elements and the receiving antenna elements each have a fractal arrangement of antenna elements.

3. The three-dimensional antenna arrangement according to claim 1, wherein the three-dimensional lattice includes a face-centered cubic FCC lattice.

4. Three-dimensional antenna arrangement according to claim 1, wherein the three-dimensional lattice includes an HCP lattice.

5. The three-dimensional antenna arrangement according to claim 1, wherein the transmitting antenna elements and/or the receiving antenna elements form a tetrahedron, including at least four antenna elements, in the three-dimensional lattice.

6. The three-dimensional antenna arrangement according to claim 5, wherein the virtual antenna arrangement resulting from spatial convolution of the tetrahedral arrangement of the transmitting antenna elements and of the tetrahedral arrangement of the receiving antenna elements forms a Sierpinski tetrahedron.

7. The three-dimensional antenna arrangement according to claim 1, wherein the transmitting antenna elements and/or the receiving antenna elements are arranged rotated about one of the three spatial axes.

8. The three-dimensional antenna arrangement according to claim 1, wherein the three-dimensional antenna arrangement includes a three-dimensional MIMO antenna arrangement.

9. The three-dimensional antenna arrangement according to claim 1, wherein a wave vector of emitted waves and received waves can be determined three-dimensionally by the virtual antenna arrangement.

10. A device, comprising:
a three-dimensional antenna arrangement including:
multiple transmitting antenna elements and multiple receiving antenna elements, wherein the transmitting antenna elements and the receiving antenna elements are arranged on a regular three-dimensional lattice, and a virtual antenna arrangement of virtual antenna elements results from geometric convolution of an arrangement of the transmitting antenna elements and of an arrangement of the receiving antenna elements, wherein a phase difference of the virtual antenna elements of the virtual antenna arrangement is measurable in a third spatial dimension; and
a signal processing unit connected to the three-dimensional antenna arrangement.

11. The device according to claim 10, wherein the device is a radar device.

12. The device according to claim 10, wherein the device is a communication device.
